(19) United States
(12) Patent Application Publication
(10) Pub. No.: US 2011/0120794 A1
(43) Pub. Date: May 26, 2011

(54) Chain Gear, Vehicle Comprising a Chain Gear and Method for Transforming a motor Torque in a Vehicle

(75) Inventor: Rudolf Höbel, Egling (DE)

(73) Assignee: CLEAN MOBILE AG, Singapore (SG)

(21) Appl. No.: 12/866,035

(22) PCT Filed: Feb. 4, 2009
(86) PCT No.: PCT/IB2009/050451

§ 371 Date: Nov. 2, 2010

(30) Foreign Application Priority Data
Feb. 4, 2008 (DE) 10 2008 007 710.0
Mar. 5, 2008 (DE) 10 2008 012 797.3

(51) Int. Cl. B62M 6/55; F16H 7/06

(52) U.S. Cl. 180/206.4; 474/148

(57) ABSTRACT

A chain gear (1) for gearing an engine torque comprises three gearing stages, wherein the first gearing stage is formed by a first gear rim (6) and a fourth gear rim (9), the second gearing stage is formed by a second gear rim (7) and a fifth (10) gear rim, and the third gearing stage is formed by a third gear rim (8) and a sixth gear rim (11). The first gear rim (6), the second gear rim (7) and the third gear rim (8) are disposed on a first shaft (3), and the fourth gear rim (9), the fifth gear rim (10) and the sixth gear rim (11) are disposed on a second shaft (4). A transmission chain (27, 28, 29) is provided in each gearing stage for transmitting the torque.

The invention relates to a chain gear and a vehicle comprising a chain gear which comprises both a pedal drive and an electric motor drive. It further relates to a method for transforming a motor torque in a vehicle.

Two-wheelers with electric motors such as bicycles with electric drives, for example, generally have a gear which permits the electric motor to be operated at a favourable speed while at the same time allowing the rider to pedal at a comfortable rate.

A bicycle with an electric motor in the form of a quill motor with a toothed wheel gear such as a planet gear, for example, is known from DE 20 2007 002 368 U1.

A bicycle comprising an electric motor with integrated reducing gear fixed to the bicycle frame, the torque from the electric motor being transmitted to the pedal bearing shaft by means of a chain, is known from DE 40 27 365 A1. A similar bicycle is also known from DE 299 04 342 U1.

The object of the invention is to specify a gear which is able to convert the torque of an electric motor with good reliability, maintainability and efficiency.

In addition, a further object of the invention is to specify a vehicle with a gear of this type which can be operated with particular energy efficiency and simultaneously offers the rider a high level of comfort.

This object is achieved according to the invention by means of the subject-matter of the independent claims. Advantageous developments of the invention are disclosed in the dependent claims.

A gear as according to the invention is known as a chain gear. It comprises three gearing stages wherein the first gearing stage is formed by a first gear rim and a fourth gear rim, the second gearing stage is formed by a second gear rim and a fifth gear rim and the third gearing stage is formed by a third gear rim and a sixth gear rim. The first gear rim, the second gear rim and the third gear rim are arranged on a first shaft and the fourth gear rim, the fifth gear rim and the sixth gear rim are arranged on a second shaft. A chain gear is provided in each gearing stage for the transmission of torque.

According to an underlying principle of the invention, a chain gear offers a relatively high degree of efficiency coupled with good maintainability. Under certain circumstances, however, chain gears require more space than toothed wheel gears, for example. A space-saving arrangement of the individual components of the chain gear is therefore desirable. A three-stage chain gear design is favourable since in such a case the necessary gear rims can be arranged on two shafts, one of which is designed as or is connected to the drive shaft of the electric motor. The other shaft is designed as the pedal bearing shaft of the vehicle. As a result the three chains can be arranged essentially parallel to one another in a highly space-saving configuration.

At the same time, this three-stage chain gear permits sufficient reduction to allow the electric motor to be operated in a favourable speed range of 2500 revolutions per minute, for example, while nevertheless guaranteeing a high degree of riding comfort since it is possible to achieve a reduction ratio of 1:45, for example.

In one embodiment the transmission ratio of the chain gear is therefore less than 1 and the motor speed is thus reduced.

In one embodiment of this arrangement the first gear rim comprises a number of teeth n₁, the second gear rim a number n₂, the third gear rim a number n₃, the fourth gear rim a number n₄, the fifth gear rim a number n₅ and the sixth gear rim a number n₆, where n₁<n₄, n₃<n₆ and n₅<n₂. The speed is therefore reduced at each gearing stage.

In one embodiment of this arrangement n₁=n₃=n₅ and n₂=n₄=n₆. Thus this embodiment features three identical small gear rims and three identical large gear rims. This design is particularly simple and has the added advantage of a high level of symmetry as a result of which three chains of the same kind can be used as the gear chains.

The gear according to the invention can thus be made up of a particularly small number of different components if three chains of the same kind and two sets of three gear rims of the same kind forming three gear rim pairs of the same kind are used. Alternatively, the gear ratio can be varied by replacing a gear rim or a gear rim pair.

In one embodiment the second gear rim and the third gear rim are arranged on a common first quill shaft, also known as hollow shaft, which has an axis of rotation which coincides with the axis of rotation of the first shaft. The fourth gear rim and the fifth gear rim are arranged on a second common quill shaft which has an axis of rotation which coincides with the axis of rotation of the second shaft. The use of the quill shafts results in a particularly compact gear design.

In an alternative embodiment, split shafts are used in place of the quill shafts or one of the quill shafts. For example, the first shaft may be of split design and have a first region and a second region which are able to rotate separately but yet about the same axis. The first region of the first shaft is connected to the electric motor. The first gear rim is arranged in the first region and the second gear rim and the third gear rim are arranged in the second region of the first shaft.

In one embodiment the sixth gear rim comprises a first free-wheel. It is therefore possible to use the vehicle when the motor is switched off, because due to the free-wheel it is possible to decouple the rotational movement of the sixth gear rim and thus of the motor from the rotational movement of the second shaft and thus of the pedals.

The chain gear according to the invention can be used in a vehicle to achieve a large reduction in motor torque and at the same time to save space. It is therefore possible to arrange the gear in the region of the pedal bearing shaft which is also favourable in terms of achieving a low centre of gravity for the vehicle.

The chain gear according to the invention can be configured with a diameter less than or at most equal to the diameter of a conventional front chain wheel. The chain gear according to the invention can therefore be integrated particularly well into the vehicle frame and, when fitted, offers good ground clearance together with a pleasing appearance. The chain gear can thus form an integral component of the vehicle frame. Further advantages of the use of a chain gear are that it operates with particularly low noise, that it is at the same time simple to manufacture and that it offers a high degree of efficiency.

In one embodiment the transmission ratio of the chain gear is at least 1:100 and at most 1:25, while in another embodiment it is actually at least 1:50 and at most 1:40. A transmission ratio in this range permits particularly good adjustment of the motor speed—which is favourably of the order of at least 1000 revolutions per minute—to the pedalling rate of the average rider.

According to one aspect of the invention a vehicle has the chain gear according to the invention, said vehicle having both a pedal drive and an electric motor drive. The drive shaft of the electric motor and the drive shaft of the pedal drive are coupled together by the chain gear. In one embodiment of this arrangement the first shaft is designed as the drive shaft of the electric motor and the second shaft is designed as the pedal bearing shaft of the vehicle.

The vehicle may be designed as a two-wheeler, a three-wheeler or a four-wheeler, for example. If it is designed as a three-wheeler, arrangements in which two wheels are positioned side by side at the rear and arrangements in which two wheels are positioned side by side at the front are both conceivable. However, embodiments with one single front wheel offer more favourable cornering behaviour.

Both the front wheel or wheels and the rear wheel or wheels may be driven.

In one embodiment a seventh gear rim, which is connected by a chain to a rear gear rim of a rear wheel of the vehicle, is arranged on the second shaft.

Alternatively, the seventh gear rim is connected to the gear rim of a differential gear. This is particularly advantageous if the vehicle is designed as a four-wheeler or a three-wheeler in which the two wheels that are arranged side by side are driven.

The seventh gear rim advantageously comprises a second free-wheel such that the rider is not required to pedal or, respectively, the electric motor is not required to operate while the vehicle is moving.

The chain gear is of particularly compact design and can therefore be arranged with great ease in a housing connected to a frame of the vehicle. In such an arrangement the housing has at least one lateral protection which prevents the gear chain from injuring the rider. However, it can also be of predominantly closed design in order to prevent the penetration of dirt and humidity to a large extent.

According to one aspect of the invention, a method for transforming a motor torque in a vehicle with an electric motor drive and a pedal drive has the following steps: first transforming of torque from a first gear rim to a fourth gear rim by means of a first gear chain; second transforming of the torque from a second gear rim to a fifth gear rim by means of a second gear chain; third transforming of torque from a third gear rim to a sixth gear rim by means of a third gear chain, the sixth gear rim being connected to a pedal bearing shaft of the vehicle; transforming of torque from the pedal bearing shaft to a chain wheel assigned to a rear wheel of the vehicle by means of a chain.

Herein, a pedal torque is able to engage at the pedal bearing shaft in addition to the transmitted motor torque when the vehicle is in operation.

Embodiments of the invention are explained in greater detail below with reference to the attached figures.

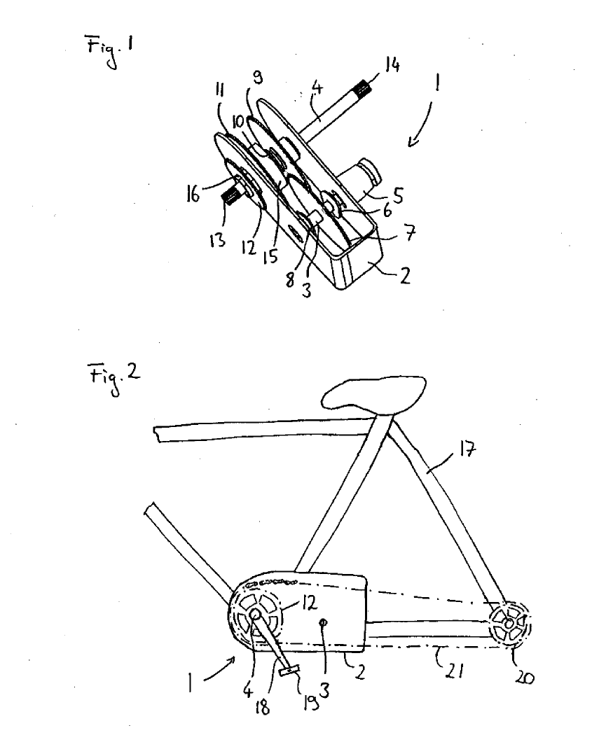

FIG. 1 shows in schematic form a perspective view of a chain gear according to one embodiment of the invention;

FIG. 2 shows in schematic form a section from a vehicle with a chain gear according to one embodiment of the invention.

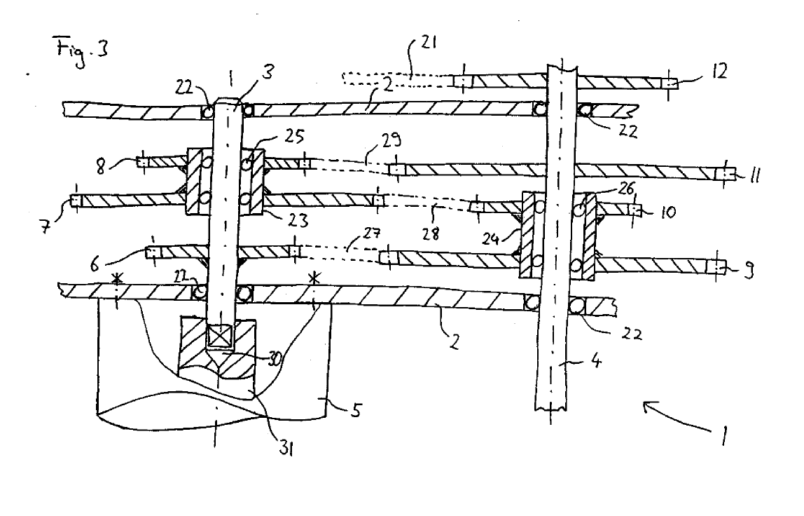

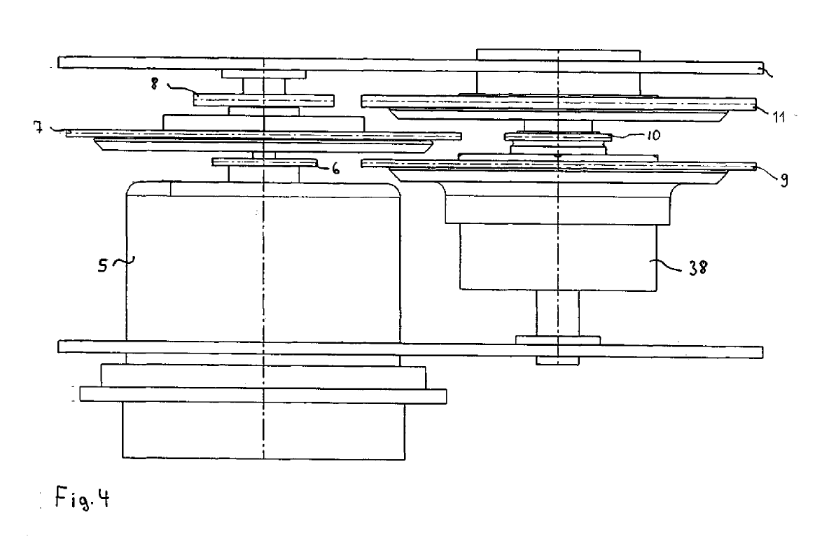

FIG. 3 shows in schematic form a cross-section through a chain gear according to one embodiment of the invention.

Identical parts are indicated by the same reference numerals in all figures.

FIG. 1 shows in schematic form a perspective view of a chain gear 1 according to one embodiment of the invention. The chain gear 1 comprises a first gear rim 6, a second gear rim 7, a third gear rim 8, a fourth gear rim 9, a fifth gear rim 10 and a sixth gear rim 11, wherein the first gear rim 6, the second gear rim 7 and the third gear rim 8 are arranged on a first shaft 3 and the fourth gear rim 9, the fifth gear rim 10 and the sixth gear rim 11 are arranged on a second shaft 4.

The first shaft 3 is connected to the drive shaft of an electric motor 5.

The second shaft 4 is designed as the pedal bearing shaft of a vehicle and has a first end 13 and a second end 14, the first end 13 and the second end 14 being suitable for receiving cranks with pedals, which are not illustrated in FIG. 1.

The first gear rim 6, the third gear rim 8 and the fifth gear rim 10 are of relatively small diameter and thus have a small number of teeth. In contrast, the second gear rim 7, the fourth gear rim 9 and the sixth gear rim 11 are of relatively large diameter and thus have a larger number of teeth.

Provided between the sixth gear rim 11 and the second shaft 4 is a first free-wheel 15 which permits the sixth gear rim 11 to be decoupled from the second shaft 4.

Also arranged on the second shaft 4 is a seventh gear rim 12 which has a second free-wheel 16.

A first gear chain, that is not shown for reasons of clarity, connects the first gear rim 6 to the fourth gear rim 9, a second gear chain that is similarly not shown connects the second gear rim 7 to the fifth gear rim 10 and a third gear chain that is also not shown connects the third gear rim 8 to the sixth gear rim 11.

The chain gear 1 is accommodated in a housing 2 which receives the first gear rim 6, the second gear rim 7, the third gear rim 8, the fourth gear rim 9, the fifth gear rim 10 and the sixth gear rim 11 as well as the first gear chain, the second gear chain and the third gear chain. Therein, the housing 2 takes the form at least of a lateral protection for the chain gear 1 and the rider of the vehicle.

In an alternative embodiment of the invention (not shown) the electric motor 5 is arranged inside the housing 2.

The electric motor 5 can be of small design and operate at high speed. Thus it is possible to provide a particularly compact drive unit for a vehicle which also has a high degree of efficiency.

FIG. 2 shows in schematic form a section from a vehicle with a chain gear 1 according to one embodiment of the invention.

In the embodiment shown, the vehicle is designed as a two-wheeler. The chain gear 1 is integrated in the frame 17 of the vehicle and comprises the pedal bearing shaft of the vehicle, wherein cranks 18 with pedals 19 are arranged on the second shaft 4. A chain 21 connects the seventh gear rim 12 to a rear gear rim 20 on the rear wheel of the two-wheeler.

In an embodiment that is not illustrated here in which the vehicle is designed as a four-wheeler or a three-wheeler with two driven wheels, the chain connects the seventh gear rim to the gear rim of a differential gear.

The vehicle may also have on its rear wheel a sprocket cluster of a gear change, from which only the rear gear rim 20 is illustrated symbolically in FIG. 2.

FIG. 3 shows in schematic form a cross-section through a chain gear 1 according to one embodiment of the invention.

The first shaft 3 and the second shaft 4 are supported on ball bearings 22 in the housing 2. The first gear rim 6 is connected rigidly to the first shaft 3 and welded to it. The sixth gear rim 11 is connected to the second shaft 4 but its rotational movement can be decoupled from the rotational movement of the second shaft 4 by the first free-wheel which is not illustrated in FIG. 3.

The second gear rim 7 is arranged together with the third gear rim 8 on a common first quill shaft 23 which has an axis of rotation which coincides with the axis of rotation of the first shaft 3. The fourth gear rim 9 is arranged together with the fifth gear rim 10 on a second quill shaft 24 which has an axis of rotation that coincides with the axis of rotation of the second shaft 4. The first quill shaft 23 is supported on the first shaft 3 by means of a first ball bearing 25 and the second quill shaft 26 is supported on the second shaft 4 by means of a second ball bearing 26.

The first chain gear 27 connects the first gear rim 6 to the fourth gear rim 9, the second gear chain 28 connects the second gear rim 7 to the fifth gear rim 10 and the third gear chain 29 connects the third gear rim 8 to the sixth gear rim 11.

Therein, the gear chains 27, 28, 29 are designed as motor chains, for example, and are able to withstand high forces.

The first shaft 3 is connected to the drive shaft 31 of the electric motor 5 and housed in a receiver 30 of the drive shaft 31. The electric motor 5 can thus be removed simply for maintenance or replacement purposes with no need to dismantle the chain gear 1.

In operation, the electric motor 5 drives the first shaft 3 at a relatively high speed of the order of at least 1000 revolutions per minute, for example at 2000 to 3500 revolutions per minute, for example at 2500 revolutions per minute.

The first gear rim 6 which is arranged rigidly on the first shaft 3 transmits the torque to the fourth gear rim 9 by means of the first gear chain 27. In the embodiment illustrated the first gear rim 6 comprises 17 teeth and the fourth gear rim 9 comprises 61 teeth. This results in a reduction ratio for this first gearing stage of approximately

1:3.59.

The fourth gear rim 9 is arranged together with the fifth gear rim 10 on the common second quill shaft 24. The fifth gear rim 10, which has 17 teeth in the embodiment shown, transmits the torque on to the second gear rim 7, which has 61 teeth in the embodiment shown, by means of the second gear chain 28. Thus, also for the second gearing stage, a reduction ratio of approximately 1:3.59 results.

The third gear rim 8 is arranged together with the second gear rim 7 on the common first quill shaft 23. The third gear rim 8, which has 17 teeth in the embodiment shown, transmits the torque on to the sixth gear rim 11, which has 61 teeth in the embodiment shown, by means of the third gear chain 29. Thus, also for the third gearing stage, a reduction ratio of approximately 1:3.59 results.

The chain gear 1 according to the invention thus has three gearing or rather reduction stages, these three gearing stages being of the same design in the embodiment shown since the first gear rim 6, the third gear rim 8 and the fifth gear rim 10 and the second gear rim 7, the fourth gear rim 9 and the sixth gear rim 11 each have the same number of teeth. It is therefore also possible to use three completely identical gear chains 27, 28, 29.

In a further embodiment the chains of the two first gearing stages each have a width of 6 mm, while the chain of the third gearing stage has a width of 8 mm.

Overall, the chain gear according to the invention in the embodiment shown achieves a reduction of approximately

1:46.2 between the electric motor 5 and the second shaft 4 with the seventh gear rim 12. The pedalling rate of the driver can therefore be at a ratio of 1:46.2 to the rate of the electric motor. At typical comfortable rider pedalling rates, which corresponds to 45 to 70 revolutions per minute, it is therefore possible to operate the electric motor at a high speed at 2000 to 3200 revolutions per minute in a range with a high degree of efficiency.

FIG. 4 shows a further gear which as an additional free-wheel 38 not included in the gear illustrated in FIG. 3. In a first embodiment the free-wheel 38 is provided such that the motor 5 is able to drive the seventh gear rim 12 via the gear without the pedals turning.

In a second embodiment the free-wheel can also be locked. This is particularly advantageous if braking energy is to be used for the recuperation of electrical energy. Thereby, the running wheel can drive the electric motor 5 via the seventh gear rim in generator mode without being prevented from doing so by the free-wheel 38.

In a third embodiment the direction of the free-wheel 38 can be reversed. This allows for reverse gearing during which the electric motor changes its direction of rotation and thus drives the vehicle backwards. Here once again the free-wheel means that the pedals do not have to turn at the same time. The reversal also permits energy recuperation as described above.

### LIST OF REFERENCE NUMERALS

1 Chain gear
2 Housing
3 First shaft
4 Second shaft
5 Electric motor
6 First gear rim
7 Second gear rim
8 Third gear rim
9 Fourth gear rim
10 Fifth gear rim
11 Sixth gear rim
12 Seventh gear rim
13 First end
14 Second end
15 First free-wheel
16 Second free-wheel
17 Frame
18 Cranks
19 Pedals
20 Rear gear rim
21 Chain
22 Ball bearing
23 First quill shaft
24 Second quill shaft
25 First ball bearing
26 Second ball bearing
27 First gear chain
28 Second gear chain
29 Third gear chain
30 Reception
31 Shaft
n₁ Number of teeth in first gear rim
n₂ Number of teeth in second gear rim
n₃ Number of teeth in third gear rim
n₄ Number of teeth in fourth gear rim
n₅ Number of teeth in fifth gear rim
n₆ Number of teeth in sixth gear rim

1. Chain gear for transforming a motor torque of an electric motor (5) comprising the following:
three gearing stages, the first gearing stage being formed by a first gear rim (6) and a fourth gear rim (9), the second gearing stage being formed by a second gear rim (7) and a fifth (10) gear rim and the third gearing stage being formed by a third gear rim (8) and a sixth gear rim (11);
the first gear rim (6), the second gear rim (7) and the third gear rim (8) are arranged on a first shaft (3) and the fourth gear rim (9), the fifth gear rim (10) and the sixth gear rim (11) are arranged on a second shaft (4);
a gear chain (27, 28, 29) is provided in each gearing stage to transmit the torque,
wherein the first shaft (3) is designed as a drive shaft of the electric motor (5) and the second shaft (4) is designed as a pedal bearing shaft of a vehicle.

2. Chain gear according to claim 1, wherein
the transmission ratio of the chain gear (1) is less than 1.

3. Chain gear according to claim 2, wherein
the first gear rim (6) comprises a number n₁ of teeth, the second gear rim (7) having a number n₂, the third gear rim (8) comprises a number n₃, the fourth gear rim (9) comprises a number n₄, the fifth gear rim (10) a number n₅ and the sixth gear rim (11) a number n₆,
where
n₁<n₄,
n₃<n₆ and
n₅<n₂.

4. Chain gear according to claim 3,
where
n₁=n₃=n₅ and
n₂=n₄=n₆.

5. Chain gear according to claim 1, wherein three chains of the same kind are provided as gear chains (27, 28, 29).

6. Chain gear according to claim 1, wherein the gear chains (27, 28) of the first and second gearing stages have lower widths than the gear chain (29) of the third gearing stage.

7. Chain gear according to claim 1, wherein the second gear rim (7) and the third gear rim (8) are arranged on a common first quill shaft (23) which has an axis of rotation which coincides with the axis of rotation of the first shaft (3).

8. Chain gear according to claim 1, wherein the first shaft (3) is of split design and comprises a first region and a second region which are able to rotate separately from one another but about the same axis, wherein the first region is connected to the electric motor (5) and the first gear rim (6) is arranged on the first region and the second gear rim (7) and the third gear rim (8) are arranged on the second region of the first shaft (3).

9. Chain gear according to claim 1, wherein the fourth gear rim (8) and the fifth gear rim (9) are arranged on a common second quill shaft (24) which comprises an axis of rotation which coincides with the axis of rotation of the second shaft (4).

10. Chain gear according to claim 1, wherein the sixth gear rim (11) comprises a first free-wheel (15).

11. Chain gear according to claim 2, wherein the transmission ratio of the chain gear (1) is at least 1:100 and at most 1:25.

12. Chain gear according to claim 11, wherein the transmission ratio of the chain gear (1) is at least 1:50 and at most 1:40.

13. Vehicle with a chain gear according to claim 1, wherein the vehicle comprises both a pedal drive and an electric motor drive, wherein the drive shaft of the electric motor and the drive shaft of the pedal drive are coupled together by the chain gear (1).

14. Vehicle according to claim 13, wherein a seventh gear rim (12) which is connected to a rear gear rim (20) of the vehicle by a chain (21) is arranged on the second shaft (4).

15. Vehicle according to claim 14, wherein the rear gear rim (20) is assigned to a rear wheel of the vehicle.

16. Vehicle according to claim 14, wherein the rear gear rim (20) is assigned to a differential gear of the vehicle.

17. Vehicle according to claim 14, wherein the seventh gear rim (12) comprises a second free-wheel (16).

18. Vehicle according to claim 13, wherein the chain gear (1) is arranged in a housing (2) which is connected to a frame (17) of the vehicle.

19. Vehicle according to claim 18, wherein the housing (2) and the chain gear (1) form an integral component of the frame (17) of the vehicle.

20. Vehicle according to claim 13, wherein the vehicle is designed as a two-wheeler.

21. Vehicle according to claim 13, wherein the vehicle is designed as a three-wheeler.

22. Vehicle according to claim 13, wherein the vehicle is designed as a four-wheeler.

23. Vehicle according to claim 14, wherein a free-wheel (38) is provided such that the electric motor (5) is able to drive the seventh gear rim without the pedals turning.

24. (canceled)

25. (canceled)

26. Method for transforming a motor torque in a vehicle comprising an electric motor drive and a pedal drive, the method comprising the following steps:
first transforming of torque from a first gear rim (6) to a fourth gear rim (9) by means of a first gear chain (27);
second transforming of torque from a second gear rim (7) to a fifth gear rim (10) by means of a second gear chain (28);
third transforming of torque from a third gear rim (8) to a sixth gear rim (11) by means of a third gear chain (29), the sixth gear rim (11) being connected to a pedal bearing shaft (4) of the vehicle;
transforming of torque from the pedal bearing shaft (4) to a chain wheel (20) assigned to a rear wheel of the vehicle by means of a chain (21).

27. (canceled)

28. (canceled)

29. (canceled)

30. (canceled)
